(19) United States
(12) Patent Application Publication
(10) Pub. No.: US 2024/0171007 A1
(43) Pub. Date: May 23, 2024

(54) WIRELESS CHARGER

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventor: LING-JIE WANG, New Taipei (TW)

(21) Appl. No.: 18/508,632

(22) Filed: Nov. 14, 2023

(30) Foreign Application Priority Data
Nov. 22, 2022 (CN) 202211467099.7

(51) Int. Cl. H02J 50/00; H02J 7/00; H02J 50/10

(52) U.S. Cl. CPC H02J 50/005; H02J 7/0044; H02J 50/10

(57) ABSTRACT

A wireless charger including: a charging body having a charging surface for placement of a device to be charged and a back surface opposite to the charging surface; and a holder cooperating with the charging body to allow the device to be charged to be tilted; wherein the charging body and the holder are provided separately, there are multiple installation grooves on the back surface, and the holder is able to be inserted into corresponding installation grooves so that the charging body is able to be tilted at multiple angles.

### BACKGROUND OF THE INVENTION

### Field of the Invention

The present invention relates generally to a wireless charger, and particularly to a wireless charger with a stand.

### Description of Related Arts

As wireless charging technology becomes more and more mature. more and more electronic products are becoming to use wireless chargers for charging. When charging, just place your mobile phone or other device with a charging coil on the charging surface of the wireless charger to achieve charging. Users sometimes need to charge their phones while using them. However, the wireless chargers currently on the market can only be placed flat for charging, or they can only be placed on the charger at a fixed angle, which cannot meet the needs of users.

An improved wireless charger is desired.

### SUMMARY OF THE INVENTION

The objective of the present invention is to provide a wireless charger, wherein the device to be charged can be placed at multiple angles when charging.

To achieve the above object, a wireless charger comprises: a charging body including a charging surface for placement of a device to be charged and a back surface opposite to the charging surface; and a holder cooperating with the charging body to allow the device to be charged to be tilted; wherein the charging body and the holder are provided separately, there are multiple installation grooves on the back surface, and the holder is able to be inserted into corresponding installation grooves so that the charging body is able to be tilted at multiple angles.

Compared to prior art, the wireless charger of the present invention has multiple installation grooves on the back thereof. The holder can be inserted into corresponding installation grooves as needed so that the charging body can be tilted at multiple angles, thereby allowing the device to be charged to be placed on the charging surface of the charging body at a desired angle.

### BRIEF DESCRIPTION OF THE DRAWING

FIG. 1 is a perspective view of a wireless charger according to the present invention;

FIG. 2 is another perspective view of the wireless charger of FIG. 1;

FIG. 3 is an exploded perspective view of the wireless charger of FIG. 1, wherein the charging body and the holder are separated;

FIG. 4 is an another exploded perspective view of the wireless charger of FIG. 1;

FIG. 5 is a further exploded perspective view of the wireless charger of FIG. 4;

FIG. 6 is a schematic view of the wireless charger of FIG. 3 before the holder is inserted into the middle installation groove;

FIG. 7 is schematic view of the wireless charger of FIG. 3 before the holder is inserted into one of the installation groove on two sides;

FIG. 8 is a side view of a usage angle of the wireless charger, wherein a lengthwise direction of the receiving cavity is at an angle with the external plane.

FIG. 9 is a side view of another usage angle of the wireless charger, wherein the lengthwise direction of the receiving cavity is at an angle with the external plane;

FIG. 10 is a side view of another usage angle of the wireless charger, wherein the lengthwise direction of the receiving cavity is at an angle with the external plane;

FIG. 11 is a side view of a usage angle of the wireless charger, wherein the lengthwise direction of the receiving cavity is parallel to the external plane; and

FIG. 12 is a side view of another usage angle of the wireless charger, wherein the lengthwise direction of the receiving cavity is parallel to the external plane.

### DETAILED DESCRIPTION OF THE PREFERRED EMBODIMENT

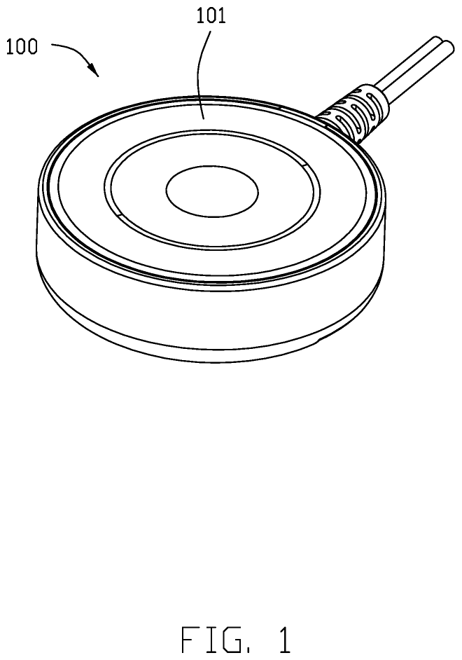

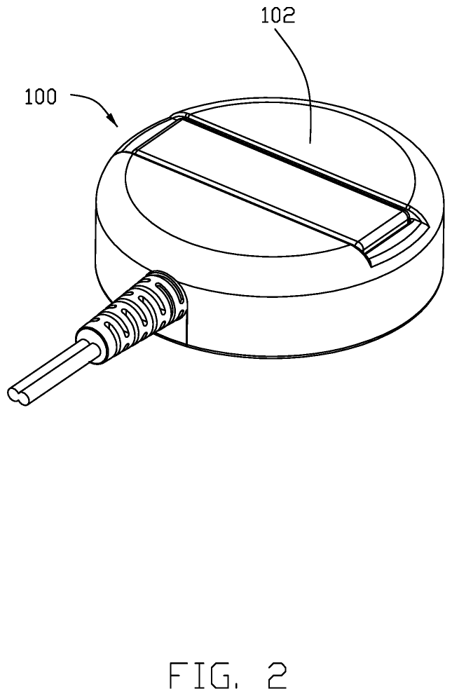

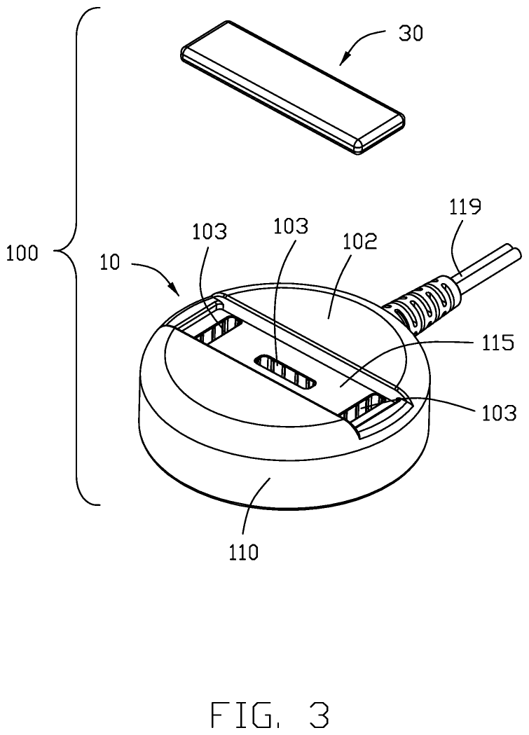

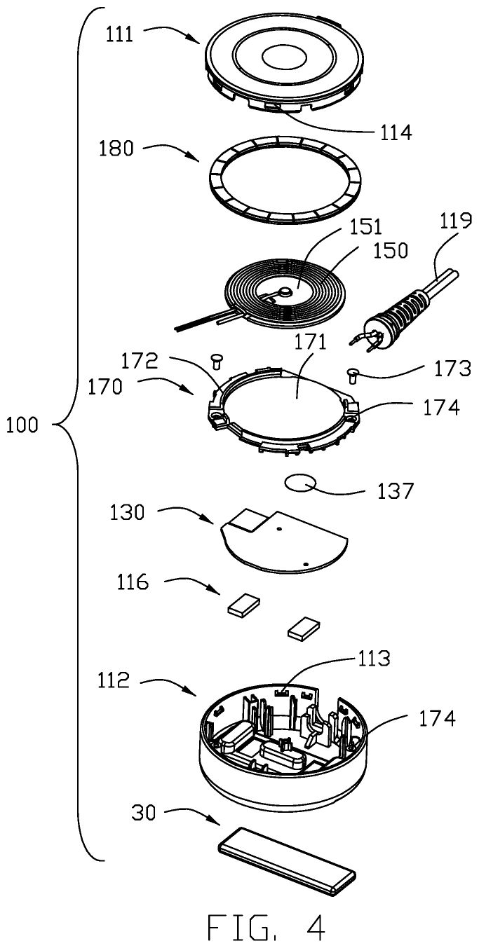

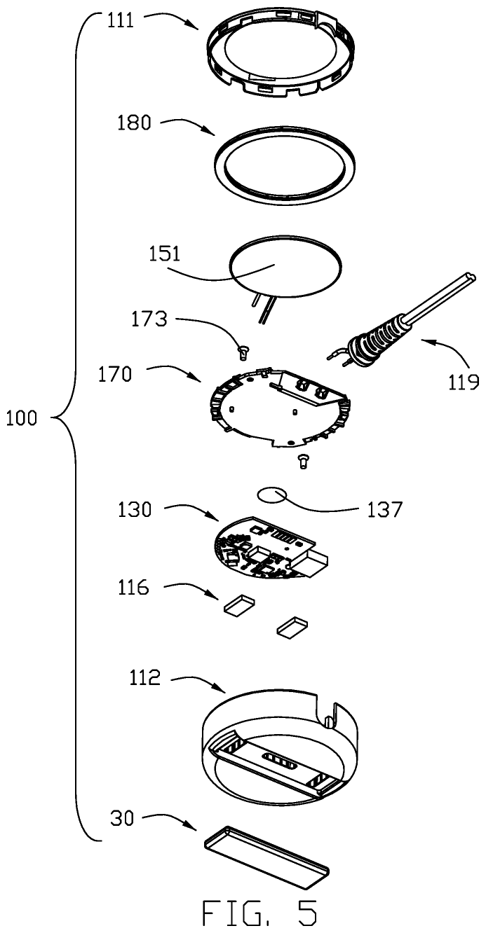

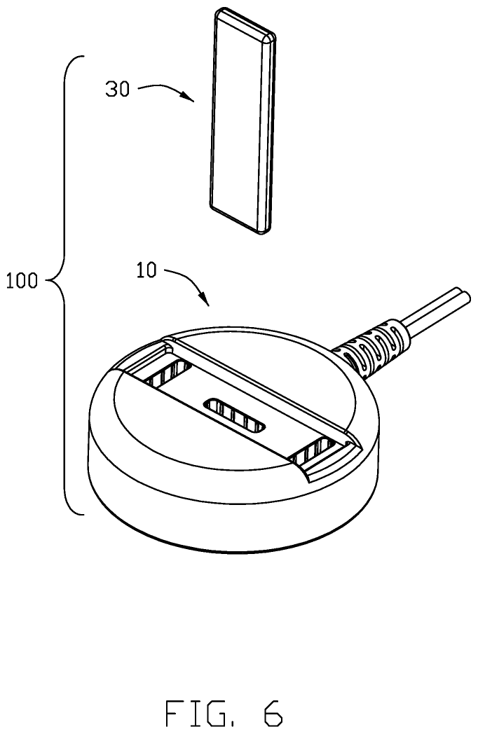

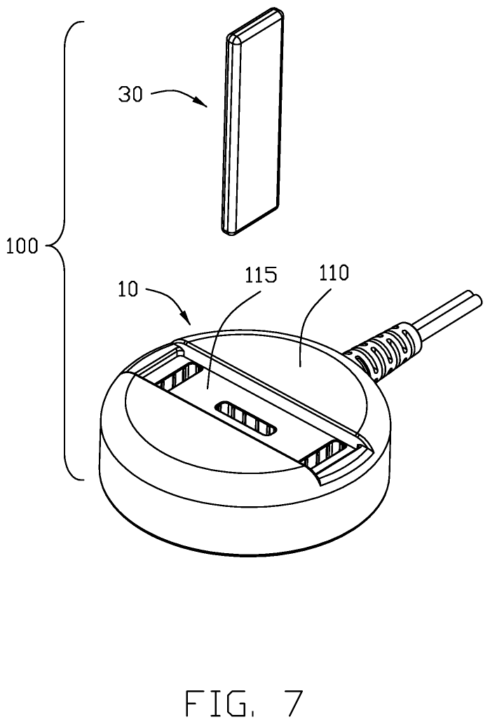

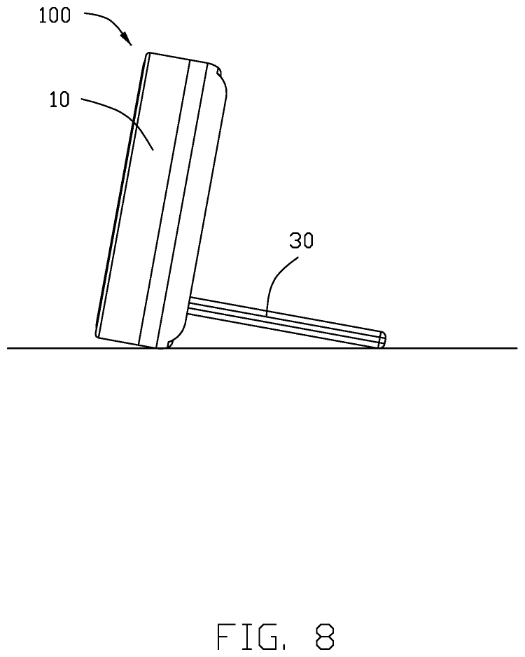

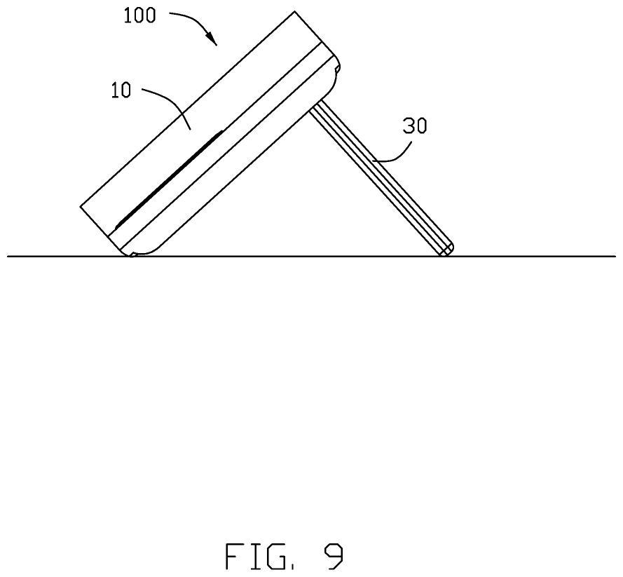

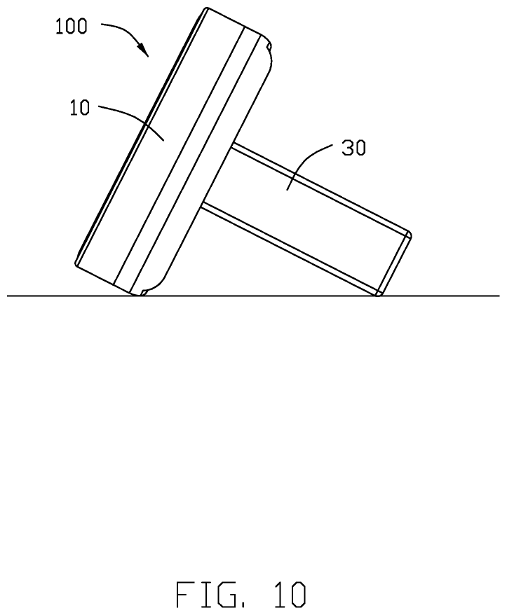

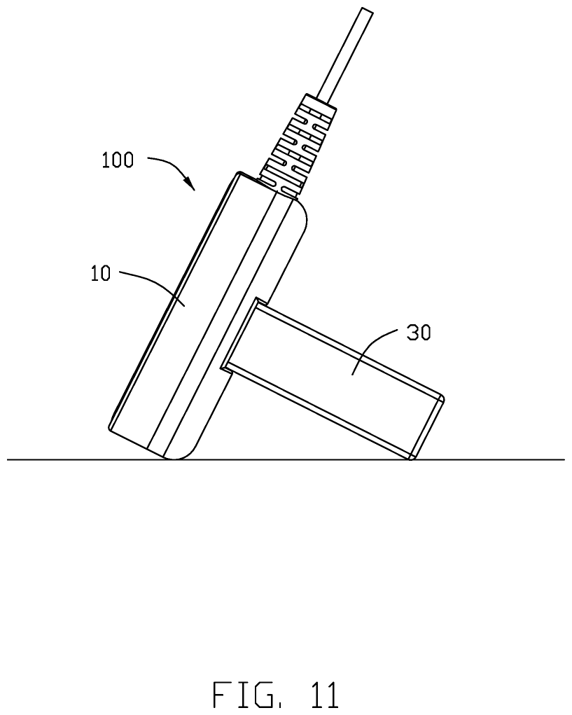

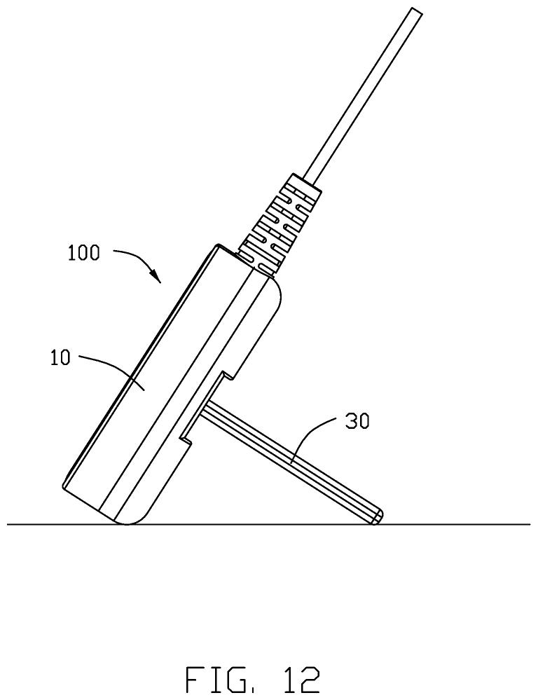

Referring to FIGS. 1-12, a wireless charger 100 in accordance with the present invention is shown. The wireless charger 100 includes a charging body 10 and a holder 30 that cooperates with the charging body 10. The holder 30 allows the electronic device to be charged can be placed at an angle. For ease of understanding, the electronic device in the present invention takes a mobile phone as an example. Of course, it can also be other electronic devices with a display screen.

In the present invention, the charging body 10 and the holder 30 are separate. The charging body 10 includes an outer shell 110, a circuit board 130 received in the outer shell 110, a charging coil 150 for charging the mobile phone, an middle shell 170 located between the charging coil 150 and the circuit board 130, and a magnetic element 180 that can magnetically attract the mobile phone to the charging body 10.

The outer shell 110 includes an upper shell 111 and a lower shell 112 mated with the upper shell 111. The lower shell 112 has an engaging protrusion 113, and the upper shell 111 has an engaging hole 114. The upper shell 111 and the lower shell 112 are engaged together through the engaging protrusions 113 and the engaging holes 114. The upper surface of the upper shell 111 forms a charging surface 101 that can be contacted with the mobile phone. The lower shell 112 includes a back surface 102 opposite to the charging surface 101. The back surface 102 has a plurality of installation grooves 103. The holder 30 can be inserted into the corresponding installation groove 103 as needed, so that the charging body 10 can be tilted at different angles, thereby allowing the mobile phone placed on the charging surface 101 of the charging body 10 at the required angle.

The charging coil 150 is electrically connected to the circuit board 130. The charging body 10 further includes an antimagnetic sheet 151 disposed under the charging coil 150. The charging coil 150 is placed on the antimagnetic sheet 151. The antimagnetic sheet 151 blocks electromagnetic interference between the circuit board 130 and the charging coil 150. The middle shell 170 includes a middle surface 171 that carries the antimagnetic sheet 151, and a flange portion 172 located around the middle surface 171 and higher than the middle surface 171. The antimagnetic sheet 151 is fixed on the middle surface 171 of the middle shell 170. In the present invention, the antimagnetic sheet 151 is fixed on the middle shell 170 by dispensing glue. The magnetic element 180 is annular in shape, its upper surface is opposite to the inner surface of the upper shell 111, and its lower surface is pasted and fixed on the flange portion 172 of the middle shell 170. The magnetic element 180 enables the mobile phone to be quickly positioned on the charging surface 101 of the wireless charger 100. The charging body 10 further includes an adhesive tape 137 that firmly connects the circuit board 130 and the middle shell 170, and multiple screws 173 that fix the middle shell 170 and the lower shell 112 together. The flange portion 172 and the lower shell 112 are both provided with screw holes 174. The circuit board 130 is fixed and received between the lower shell 112 and the middle shell 170.

During assembly, the charging coil 150 and the magnetic element 180 are fixed on the upper surface of the middle shell 170, the circuit board 130 is fixed on the lower part of the middle shell 170, and then the middle shell 170 is fix it to the lower shell 112 with the screws 173, and then the upper shell 111 is fastened to the lower shell 112. The middle shell 170 increases the structural strength of the charging body 10.

The shape of the holder 30 is a cuboid, and its cross-sectional shape is a rectangle. The interior 102 of the lower shell 112 is provided with a receiving cavity 115. The shape of the receiving cavity 115 matches the shape of the holder 30. The holder 30 can be completely accommodated in the receiving cavity 115, making the wireless charger 100 more convenient to carry.

A plurality of installation grooves 103 are provided in the receiving cavity 115 and arranged along the lengthwise direction of the receiving cavity 115. Specifically, the present invention includes three installation grooves 103, and the three installation grooves 103 all match the cross-sectional shape of the bracket. A lengthwise direction of the middle installation groove 103 among the three mounting grooves 103 is along the lengthwise direction of the receiving cavity 115. The holder 30 is magnetically attracted to the charging body 10. Specifically, the holder 30 includes a first magnetic element (not shown) and an insulating material formed on the first magnetic element. The charging body 10 further includes a second magnetic element 116 disposed inside the lower shell 112 that can be magnetically attracted to the first magnetic element.

The wireless charger 100 further includes a charging cable 119. The charging cable 119 is electrically connected to the circuit board 130 and extends out of the outer shell 110. The direction in which the charging wire 119 extends out of the outer shell 110 is perpendicular to the lengthwise direction of the receiving cavity 115. The charging cable 119 is connected to an external circuit and supplies power to the mobile phone through the charging coil 150.

When using the wireless charger, take out the holder 30 from the receiving cavity 115 and insert the holder 30 into the corresponding installation groove 103 as needed, and abut the holder 30 with an external plane, so that the wireless charger 100 is tilted to the external plane, and the mobile phone is magnetically attracted to the charging surface 101 of the wireless charger 100, so that the mobile phone can be used as the required angle while charging. When not charging, the holder 30 is magnetically absorbed and accommodated in the receiving cavity 115, making it convenient to store and carry. Specifically, the present invention may include the following usage situations: the holder 30 is inserted into any one of the three installation groove 103 and can be placed on the external plane in two ways. One is that the lengthwise direction of the receiving cavity 115 is at an angle to the external plane, and the other is that the lengthwise direction of the receiving cavity 115 is parallel to the external plane. Each of the two ways can enable the mobile phone to be placed horizontally or vertically on the charging surface 101. The holder 30 can be inserted into any one of the three installation grooves 103 as needed. Inserted in each installation groove 103, there are two corresponding ways of placing it on the external plane. There are six ways of placement in total. Each of the six placement methods corresponds to two ways of placing the phone horizontally or vertically, so there are a total of twelve ways to place the mobile phone, meeting the application of various charging angles when charging mobile phones.

In the wireless charger 100 of the present invention, a plurality of installation grooves 103 are provided on the back surface 102, and the holder 30 can be inserted into corresponding installation grooves 103 as needed, so that the charging body 10 can be tilted at multiple angles, so that the device to be charged can be placed on the charging surface 101 of the charging body 10 at a desired angle.

1. A wireless charger comprising:
a charging body including a charging surface for placement of a device to be charged and a back surface opposite to the charging surface; and
a holder cooperating with the charging body to allow the device to be charged to be tilted; wherein
the charging body and the holder are provided separately, there are multiple installation grooves on the back surface, and the holder is able to be inserted into corresponding installation grooves so that the charging body is able to be tilted at multiple angles.

2. The wireless charger as claimed in claim 1, wherein the shape of the holder is a cuboid, and its cross-sectional shape is a rectangle.

3. The wireless charger as claimed in claim 1, wherein the holder is magnetically attracted to the charging body.

4. The wireless charger as claimed in claim 1, wherein the back side of the charging body is provided with a receiving cavity, and the holder is able to be completely received in the receiving cavity.

5. The wireless charger as claimed in claim 4, wherein the holder includes a first magnetic element and an insulating material formed on the first magnetic element.

6. The wireless charger as claimed in claim 5, wherein the charging body is provided with a second magnetic element capable of attracting the first magnetic element.

7. The wireless charger as claimed in claim 4, wherein the plurality of installation grooves are provided in the receiving cavity and arranged along a lengthwise direction of the receiving cavity.

8. The wireless charger as claimed in claim 7, wherein there are three installation grooves, a lengthwise direction of the middle installation groove of the three installation grooves is along the lengthwise direction of the receiving cavity, a lengthwise direction of each of the two installation grooves located on sides is perpendicular to the lengthwise direction of the receiving cavity.

9. The wireless charger as claimed in claim 4, wherein the charging body includes an outer shell, a circuit board contained in the outer shell, a coil for charging the device to be charged, and a magnetic element magnetically attracting the device to be charged on the charging body.

10. The wireless charger as claimed in claim 9, further including a charging cable connected to the circuit board and extending out of the outer shell, and the direction in which the charging cable extends out of the outer shell is perpendicular to the lengthwise direction of the receiving cavity.
